(19) United States
(12) Patent Application Publication
(10) Pub. No.: US 2023/0253641 A1
(43) Pub. Date: Aug. 10, 2023

(54) PROCESSING THERMALLY PRETREATED AND UNTREATED BATTERIES AND THEIR PRODUCTION REJECTS

(71) Applicant: REDUX Recycling GmbH, Offenbach (DE)

(72) Inventors: Waldemar Kiselew, Wurster Nordseeküste (DE); Astrid Arnberger, Wien (AT)

(21) Appl. No.: 18/165,176

(22) Filed: Feb. 6, 2023

(30) Foreign Application Priority Data
Feb. 8, 2022 (DE) 10 2022 102 919.0

(51) Int. Cl. H01M 10/54; C22B 1/24; C22B 23/00; C22B 23/02; C22B 7/00

(52) U.S. Cl. CPC H01M 10/54; C22B 1/24; C22B 23/005; C22B 23/02; C22B 7/005; H01M 10/052

(57) ABSTRACT

Embodiments of the present invention relate to a system for processing battery waste. The system comprises a decomposing device for mechanically decomposing the battery waste to a, in particular strip-shaped or flake-shaped, lightweight portion and a heavyweight portion. The decomposing device comprises an outlet for commonly discharging the lightweight portion and the heavyweight portion. The system further comprises a separating unit for separating the lightweight portion from the heavyweight portion, wherein the separating unit is coupled with the decomposing device for receiving the lightweight portion and the heavyweight portion. The system further comprises a fiber compactor unit, wherein the fiber compactor unit is coupled with the separating unit for receiving the lightweight portion. The fiber compactor unit is configured for compacting the lightweight portion under a separation of a further active material.

This application claims the benefit of the filing date of German Patent Application No. 10 2022 102 919.0 filed 8 Feb. 2022, the disclosure of which is hereby incorporated herein by reference.

### TECHNICAL FIELD

Embodiments of the present invention relate to a system and a method of processing battery waste.

### TECHNOLOGICAL BACKGROUND

In the manufacture of rechargeable batteries, in particular in case of lithium-ion batteries, large amounts of production rejects occur. The production rejects (so-called bicells) are in particular already stacked electrode packets (so-called anode-separator-cathode-separator units) which are not yet mixed with the electrolyte of the battery. Furthermore, it is also necessary to process complete batteries, i.e. with a housing, with or without the electrolyte.

Examples for recyclable components of a battery are e.g. electrode foils or plastic separators. Such a separator has the tasks to electrically separate the electrode foils, which may be configured as a cathode and as an anode, from each other and to ensure the ion exchange. For example, the ion-permeable membrane of a separator consists of plastic material to a large part, such as polymers, e.g. polyethylene (PE) and polypropylene (PP).

In a recycling operation of lithium-ion batteries, a thermal pretreatment may be performed prior to a mechanical processing. In the thermal treatment stage, for example the separator is burned and does not constitute an obstacle for the further treatment anymore. In the mechanical processing, for example long polymer-strings may be generated, which partially agglutinate and entangle, which cause production downtimes and clogging in the tubes and/or the conveyor line.

### SUMMARY OF THE INVENTION

There may be a need to provide a recycling possibility or a processing possibility for battery waste, which ensures a robust and disturbance-free plant operation with or without a thermal pretreatment method.

This need is met by a system and a method for processing battery waste according to the independent claims.

According to a first aspect of the present invention, a system for processing battery waste is described. The system comprises a decomposing device (German: Aufschlussvorrichtung) for mechanically decomposing the battery waste to a, in particular strip-shaped, fiber-shaped, or flake-shaped, lightweight portion and a heavyweight portion, wherein the decomposing device comprises an outlet for commonly discharging the lightweight portion and the heavyweight portion.

Furthermore, the system comprises a separating unit for separating the lightweight portion from the heavyweight portion, wherein the separating unit is coupled with the decomposing device for receiving the lightweight portion and the heavyweight portion.

Furthermore, the system comprises a fiber compactor unit, wherein the fiber compactor unit is coupled with the separating unit for receiving the lightweight portion. The fiber compactor unit is configured for compacting the lightweight portion under a separation of a further active material or a further heavyweight portion.

According to a further aspect of the present invention, a method of processing battery waste, in particular by the above-mentioned system, is described. The battery waste is mechanically decomposed by a decomposing device to a, in particular strip-shaped or flake-shaped, lightweight portion and a heavyweight portion, wherein the decomposing device comprises an outlet for commonly discharging the lightweight portion and the heavyweight portion. The method further comprises separating the lightweight portion from the heavyweight portion by a separating unit, wherein the separating unit is coupled with the decomposing device for receiving the lightweight portion and the heavyweight portion. The method further comprises compacting the lightweight portion under a separation of a further active material or a further heavyweight portion by a fiber compactor unit, wherein the fiber compactor unit is coupled with the separating unit for receiving the lightweight portion.

With the system according to embodiments of the invention, battery waste may be processed. Processing denotes that the battery waste is processed, i.e. singularized, separated, and individually forwarded, such that the valuable materials in the battery waste can be further processed. For example, battery waste according to embodiments of the present invention consists of a complete battery which comprises corresponding electrode foils and plastic separators in a housing. In other words, battery waste may denote a battery including its housing, which is for example thermally pretreated for the processing (for removing electrolytes) and/or is thermally untreated. For example, the battery may be pre-comminuted in a feeding device (German: Aufgabevorrichtung) or may be supplied directly to the mechanical decomposing device in a non-comminuted manner. The battery may further comprise an electrolyte. Alternatively, prior to supplying to the decomposing device, the electrolyte may be removed from the battery.

The housing of a battery comprises steel or aluminum, for example. In the housing, the electrode foils are located, which may function as anode or cathode, for example. The electrode foil comprises two layers of metal oxides (for example nickel, cobalt), metal phosphates and/or graphite which are separated by a central layer, for example made of aluminum and copper. The electrode foils which function as cathode on the one hand and as anode on the other hand are separated by a plastic separator. In the installed battery cell, the plastic separator in particular has the task to electrically separate the cathode and the anode from each other and to ensure the ion exchange. Therefore, the plastic portion forms an ion-permeable membrane. The plastic separator is formed strip-shaped and comprises a lightweight portion (e.g. polymers, e.g. polyethylene (PE) and polypropylene (PP)).

As explained at the beginning, battery waste may denote complete used batteries or elements of batteries. Furthermore, battery waste may denote rejects from the battery manufacture. The battery waste comprises a lightweight portion (e.g. fine particles made of active material or plastic). After decomposing in the decomposing device, the lightweight portion may be ribbon-shaped and/or flake-shaped and flexible.

A target of processing of battery waste according to the present system is to separate valuable material, such as metals, active material, and plastics, and to further use it separately. In particular, a metal portion of the battery waste comprises steel, aluminum, copper and/or compounds of the same.

In particular, an active material portion comprises nickel, cobalt, metal oxide, metal phosphates, graphite and/or compounds of the same. Active material is in particular introduced by the electrode foils which function as cathode or anode in the battery.

For example, the plastic portion may consist of polymers, e.g. polyethylene (PE) and polypropylene (PP). In particular, the plastic portion is introduced by the plastic separators in the battery.

The term “lightweight portion” denotes a part of the battery waste which, compared to a heavyweight portion, is more lightweight and/or is present in smaller fractions than the heavyweight portion. Furthermore, the lightweight portion is defined in that way, that an equivalent aerodynamic particle diameter of the lightweight portion is larger than that of a heavyweight portion, such that, when a flow is interacting, due to the aerodynamic advantages, the lightweight portions flow along with the flow easier than the heavyweight portion. The lightweight portion consists of the above-described active material and/or the plastic material, for example.

The heavyweight portion in particular comprises metal constituents, such as steel, copper, or aluminum (for example from the cell housing of the battery). Furthermore, the heavyweight portion may also comprise active material which was not discharged with the lightweight portion.

The target of processing or recycling of battery waste is the separation and the corresponding reusability of the heavyweight portions and the lightweight portion. For this purpose, at first a mechanical decomposing method, i.e. a disintegration of the battery waste to a heavyweight portion and a lightweight portion in the decomposing device is provided. According to embodiments of the invention, the decomposition of the lightweight portion from the heavyweight portions is achieved mechanically by a decomposing device. In the decomposing device, by comminuting, shredding, pressing, cutting, and ripping, the battery waste is decomposed to the lightweight portion and the heavyweight portion. Thereby, the lightweight portion forms thread-shaped and flake-shaped structures which may cause a clogging. The heavyweight portion which e.g. consists of metallic constituents, is balled (German: verkugelt), such that, besides the thread-shaped lightweight portion, also sphere-shaped metal particles are present, such as fine-grained oxides and phosphates. Due to the mechanical decomposition according to embodiments of the invention, measures for a chemical or thermal disintegration of the lightweight portion, in particular the plastic portion, may be omitted and therefore, the mechanically obtained lightweight portion may be further processed. In particular, an ecological separating system may thus be provided.

The decomposing device comprises an outlet through which the decomposed lightweight portion and the heavyweight portion can be discharged and is conveyed to the separating unit for separating (spatially separating) the lightweight portion from the heavyweight portion. In particular, the outlet may comprise a closing unit, such as the below-mentioned flap, such that the outlet can be closed in a specific and controlled manner.

In the separating unit, the decomposed mixture of the lightweight portion and the heavyweight portion is spatially separated and is in particular discharged separately. In the separating unit, different mechanical separating mechanisms may be used. For example, the separating device may separate the lightweight portion from the heavyweight portion according to the manner of an air classifier (German: Windsichter), as described in detail below.

The separated lightweight portion is conveyed to the fiber compactor unit. Therefore, in particular prior to a further processing and separation of the single material portions in the heavyweight portion, the lightweight portion is separated and is further processed in the fiber compactor unit. Since the lightweight portion consists of a number of thread-type formations, by separating the lightweight portion prior to further processing the heavyweight portion, the risk is eliminated, that the thread-type lightweight material clogs the processing units for the heavyweight portions which are used later, such as magnetic separating units, sieves or the like.

In the fiber compactor unit, the lightweight portions are mechanically compacted and are correspondingly collected in a loading station in a loading container or in another loading package, such as a big-bag, and are prepared for the further transport. In the mechanical compaction, further active materials are released which were not yet separated in the decomposing device from the residual lightweight portion, e.g. plastics. In the fiber compactor unit, also these further active materials may be discharged and may be intended for further processing.

According to a further exemplary embodiment, the mechanical decomposing device forms an impact reactor (German: Prallreaktor), in particular with a shredder rotor. The shredder rotor comminutes and crushes the incoming battery waste, so that a decomposition to the lightweight portion and the heavyweight portion is enabled. In particular, the shredder motor may be rotated around a horizontal or vertical axis. In particular, thereby the metal constituents of the heavyweight portions become sphere-shaped and are so to speak balled. By the influence of the impact (German: Prall) to the battery waste, the decomposition of the lightweight portions and the heavyweight portions is enabled.

The decomposing device may also be configured as an impact mill (German: Prallmühle) or as a crossflow chipper (German: Querstromzerspaner).

According to a further exemplary embodiment, the decomposing device comprises an upper inlet for filling in the battery waste. The battery waste is conveyable to the inlet by continuous conveyors, e.g. a screw conveyor, a belt-conveyor, a bucket-conveyor, a rope-conveyor, in particular by an ascending conveyor. Therefore, the battery waste falls from above in the decomposing device based on the gravity. Thus, the battery waste slightly detaches from itself during the free fall in the decomposing device, such that an effective reception, for example by the shredder rotor, and a more effective separation of the lightweight portion from the heavyweight portion is enabled.

For example, the battery waste is delivered in capped closed boxes (German: Pa/oxen) and/or containers and are supplied to the plant, for example to the ascending conveyor, in a feeding device by a forklift. For this purpose, the boxes are placed by the operator in a stationary lifting and tilting device which performs the charging of a feeding funnel. The feeding funnel is located above a dosing unit which performs a continuous charging of the subsequent processing, i.e. a charging of the ascending conveyor and correspondingly of the decomposing device, to ensure a possibly homogenous mass flow. The battery waste subsequently arrives via the ascending conveyor in the impact reactor, for example, as decomposing device.

The entire charging line is configured in a dense manner and the lifting and tilting device is sucked at multiple positions. Moreover, a sucking by the underpressure in the impact reactor is performed throughout the entire feeding line. Therefore, by a central blowing device, an air flow may be generated which sucks already released lightweight portions, for example electrode foils, which are released during the feeding of the decomposing device, in the decomposing device, to not contaminate the environment.

According to a further exemplary embodiment, the outlet of the decomposing device is closable, such that, in particular by a controllable flap, the outlet for conveying the decomposed lightweight portions and heavyweight portions out of the decomposing device may be selectively (i.e. in a controlled manner) opened.

According to a further exemplary embodiment, the flap is configured for sequentially opening and for discharging the lightweight portion and the heavyweight portion through the outlet for a predetermined discharging time, wherein the discharging time is 0.25 min to 5 min, in particular 2 min. For example, the decomposing device may be operated in a batch operation, so that during a certain duration, the battery waste is decomposed, i.e. shredded, crushed, etc., for example, before the flap opens the outlet and the decomposed battery waste is further, in particular continuously or discontinuously, discharged and conveyed to the separating device.

According to a further exemplary embodiment, the separating device is arranged directly downstream of (German: hinter) the outlet of the decomposing device. For example, the separating unit is flanged directly to the outlet, so that the decomposed battery waste is directly received in the separating unit. Alternatively, the separating unit may be arranged spaced apart from the decomposing device, such that the decomposed battery waste is conveyed between the decomposing device and the separating unit via a conveying line, for example by a conveyor belt or a screw conveyor.

According to a further exemplary embodiment, the separating unit comprises a sieve for separating the lightweight portion from the heavyweight portion. Due to the thread-shaped characteristic of the lightweight portion after the decomposing device, the lightweight portions get caught in the sieve, while the heavyweight portions, for example the sphere-shaped metal constituents, can pass the sieve. Moreover, the active mass portion which was not removed yet, can be separated by the sieving.

According to a further exemplary embodiment, the separating unit functions as a flow classification, in particular according to the principle of an air classifier. The separating unit correspondingly comprises a blower for generating an air flow. The blower is controllable, such that the lightweight portion is separable from the heavyweight portion by the air flow, and the lightweight portion is conveyable to the fiber compactor unit. For example, the air flow may be generated vertically or horizontally. The lighter lightweight portions are carried by the air flow, while the heavier heavyweight portions, such as metals, leave the air flow and are therefore also separated from the lightweight portions.

According to a further exemplary embodiment, the separating unit comprises a downpipe (German: Fallrohr), in which the lightweight portion and the heavyweight portion are conveyable along a conveying direction in a loose manner, in particular vertically falling. The blower provides the air flow substantially such that the lightweight portion is separable from the heavyweight portion by the air flow. In a concrete embodiment, the separating device comprises a vertical downpipe, wherein the decomposed battery waste is centrally introduced from exterior. The air flow is vertically guided from the bottom to the top through the downpipe. Therefore, the lighter lightweight portions are carried upwards to the fiber compactor unit, while the heavier heavyweight portion falls downwards based on the gravity and can be further conveyed there.

According to an exemplary embodiment, the fiber compactor unit comprises a perforated plate (German: Lochblech), on which the lightweight portion is placeable, wherein an air flow from the separating unit transports the lightweight portion in the fiber compactor unit. The air flow is directed such that the air flow passes the perforated plate and pushes the lightweight portion against the perforated plate and blows the further active material portion through the perforated plate. The fiber compactor unit comprises a stripping unit (German: Abstreifeinheit) for stripping off the lightweight portion from the perforated plate.

In particular due to its fiber-type or flake-type characteristic, the lightweight portion is caught at the perforated plate. A further active material portion, such as the above-mentioned metal oxide, such as nickel oxides or cobalt oxides, remain in the air flow and pass the perforated plate. The further active material portion may be later separated from the air flow by a cyclone separator and by a filter.

By the pressure of the air flow on the lightweight portion which is adhered to the perforated plate, a compaction is achieved. This is additionally reinforced, since either continuously or sequentially, a stripping and/or scraping of the adhered lightweight portion is performed at the perforated plate, for example by a rotating screw, and thus the lightweight portion, which is then released and compacted, can be collected at a loading station (German: Verladestation) which is coupled to the fiber compactor unit.

According to a further exemplary embodiment, the fiber compactor unit comprises a cyclone unit with a swirl pot (German: Dralltopf) and a pressing device. An air flow of the separating unit and/or the sucking flow of the decomposing device which comprises the lightweight portion, is flowable in the cyclone unit, wherein the air flow is oriented such that the air flow circulates in the cyclone unit and thereby separates the lightweight portion from the further active material portion. The lightweight portion is conveyed downwards in the swirl pot. The swirl pot is coupled with the pressing device, such that the lightweight portion is suppliable to the pressing device. The pressing device is configured for compressing the lightweight portion. The further active material portion, separated from the lightweight portion, is flowable out of the swirl pot together with the air flow. In particular, the pressing device is an edge mill (German: Kollergangpresse), a roller press (German: Waizenpresse), or a briquette press (German: Brikettierungspresse).

According to a further exemplary embodiment, the system comprises a grain size separating unit which is coupled with the separating unit for receiving the heavyweight portion. The grain size separating unit is configured for separating the metal portion and an active material portion, in particular by grain sizes. In particular, the metal portion comprises steel, aluminum, copper, and/or compounds of the same. In particular, the active material portion consists of nickel oxides and cobalt oxides, as well as the above-mentioned compounds.

According to a further exemplary embodiment, the system comprises a metal separating unit which is coupled with the grain size separating unit for receiving the metal portion, wherein the metal separating unit is configured for separating the metal portion corresponding to the electric conductivity and/or a magnetic property. By the metal separating unit, in particular conductive and non-conductive, and/or magnetic and non-magnetic fractions of the metal portion are divided. For example, a steel (Fe)-fraction, an aluminum-copper fraction and a pure aluminum fraction may be separated and isolated by their electric conductivity and/or magnetic properties. For example, the metal separating unit may constitute a separating unit which separates the particles depending on their magnetic property from that of other particles. The metal separating unit may be selected from the group of magnetic separators, which is consisting of a grid magnetic separator or a rod magnetic separator, an overbelt magnetic separator (German: Überbandmagnetabscheider), magnetic plates, magnetic drums and magnetic rollers, or an eddy current separator for non-iron metals, and stainless steel separators, and separators for separating stainless steel portions, for example.

According to a further exemplary embodiment, the system comprises a suction unit which is coupled with the decomposing device, such that a suction flow is generatable which sucks a further part of the lightweight portion out of the decomposing unit. The suction flow may be adapted to the material composition and to the particle sizes of the lightweight portion. For example, the suction unit may adjust a volume flow between 5000 m³/h and 35000 m³/h, in particular between 8000 m³/h and 30000 m³/h, further in particular between 12000 m³/h and 28000 m³/h.

According to a further exemplary embodiment, wherein the decomposing device comprises an integrated separating system, in particular an air classifier system, which is configured such that the further part of the lightweight portion is separatable from the heavyweight portion and the lightweight portion which are discharged at the outlet.

For example, the separating system in the decomposing device comprises a deflector wheel classifier (German: Abweiseradsichter), a countercurrent classifier, or a deflection classifier, wherein for example a deflector wheel with a bladed rotor is used. By a feedback-controlled adaption of the peripheral speed and the amount of air of the suction flow from the decomposing device, a specific adaption of the separating grain size (dt) is possible between the particle sizes of the sucked further lightweight portion on the one hand and for example the heavyweight portion and the lightweight portion which are carried through the outlet on the other hand. By the deflector wheel classification, the sucked further lightweight portion can therefore be separated.

At the mechanical decomposing device, by mechanically decomposing, also further lightweight portions are generated which comprise active material and/or plastics. In particular, the active material comprises nickel oxide, cobalt oxides, graphite and/or metal phosphates. Since the further lightweight portion is present in the atmosphere in the decomposing device in a dust-type manner, the further lightweight portion is removed by the suction unit and is further transported for processing. Especially in processing the further lightweight portion which is sucked from the decomposing device, it has turned out, that a high portion of active material can be recovered later, in particular in the cyclone separator and/or a dust filter which is arranged downstream.

According to a further exemplary embodiment, the system comprises a cyclone separator which is coupled with the suction unit, such that the suction flow is flowable in the cyclone separator. The cyclone separator is configured for separating fine particles from the suction flow, wherein the fine particles comprise active material which in particular consists of nickel oxides, cobalt oxides, metal phosphates, graphite, or their compounds. The cyclone separator functions in a manner that, via the centripetal force, the fine particles are separated from the suction flow and can be separately further processed.

The suction unit may comprise a feedback of the air which is purified from the active material and other lightweight portions in the decomposing device. A relation of incoming air to circulating air in the decomposing device is from 10% to 90%, depending on the material flow to be separated and the fine portion (dust), in order to not contaminate the environment.

According to a further exemplary embodiment, the cyclone separator is further coupled with the fiber compactor unit, such that the active material from the fiber compactor unit is suppliable to the cyclone separator. Therefore, additionally the active material which is recovered in the fiber compactor unit may be separated from the air flow and further processed.

In general, in the cyclone separator, in the separating system of the decomposing device, and/or in the fiber compactor unit, the lightweight portion may be separated to plastic portions [and/or residual materials] and active material, by adjusting the separating particle diameter to a desired equivalent aerodynamic particle diameter (dae) of the fiber portions and particles of the lightweight portion, by adjusting the blower and/or the suction unit. Depending on the material flow to be separated, the active material may be completely separated from the plastic portion, for example.

According to a further exemplary embodiment, the system comprises a housing in which at least the decomposing device, the separating device, and the fiber compactor unit are arranged and are sealed from the environment. In particular, in the decomposing device and the separating unit or the fiber compactor unit, hazardous fine materials may be generated, which contaminate the environment. Due to the enclosing housing, the fine materials can be kept within the housing and can be specifically filtered. Via corresponding material locks (German: Materialschleusen), for example the battery waste, for example via the above-described ascending conveyor, may be introduced from the feeding device in the decomposing device. Furthermore, further material locks may be provided at the loading stations, so that a material discharge of the separated residual materials from the housing can be exchanged without undesirably discharging the fine particles.

According to a further exemplary embodiment, the housing comprises at least one suction opening, at which the suction unit is couplable, wherein by the suction unit, air is dischargeable out of the housing to the environment as exhaust air. At the suction unit, in particular an air filter is arranged.

According to a further exemplary embodiment, the system comprises at least one mechanical conveyor, in particular a screw conveyor, a trough chain conveyor (German: Trogkettenförderer), a conveyor belt, a tube chain conveyor (German: Rohrkettenförderer), a rope conveyor, a vibration conveyor, a bucket conveyor, an elevating conveyor, a Z-conveyor, a waved edge conveyor (German: Wellenkantenfördere), or a scraper chain conveyor (German: Kratzkettenförderer).

The conveyor is arranged between the outlet of the decomposition unit and the separating unit for transporting the lightweight portion and the heavyweight portion into the separating unit. Furthermore, a conveyor may also be arranged between the separating unit and the metal separating unit, and furthermore between the metal separating unit and the grain size separating unit. By the exemplary conveyors, the heavyweight portions are transported by a direct mechanical force transfer, i.e., not by air flows. This reduces turbulences and correspondingly a contamination of the inner atmosphere within the system/housing. Preferably, also closed conveyors may be utilized, such as an above-mentioned closed screw conveyor.

By the processing procedure of the described system according to embodiments of the invention, on the one hand the quality of the output fractions (lightweight portion and heavyweight portions (in particular metals)) can be increased and on the other hand the lightweight fraction (active material and plastic material) can be recovered. By the separation by the combination of the fiber compactor and the cyclone, an especially high-quality active material can be recovered. By the air discharge, a certain amount of active material, i.e. for example the nickel-cobalt-concentrate and/or the metal phosphate concentrate is co-separated, and by the compaction of the lightweight portion, a substantial volume reduction of the output fraction is achieved.

It is noted that embodiments of the invention are described with reference to different subject matters of the invention. In particular, some embodiments of the invention are described with device claims and other embodiments of the invention are described with method claims. However, it is immediately clear for a person skilled in the art, that, unless explicitly otherwise specified, additionally to a combination of features which belong to a type of subject matter of the invention, also an arbitrary combination of features is possible which belong to different types of subject matters of the invention.

### DETAILED DESCRIPTION OF EXEMPLARY EMBODIMENTS

In the following, for the further explanation and for a better understanding of embodiments of the present invention, embodiments are described in more detail under reference to the accompanied drawings. It is shown:

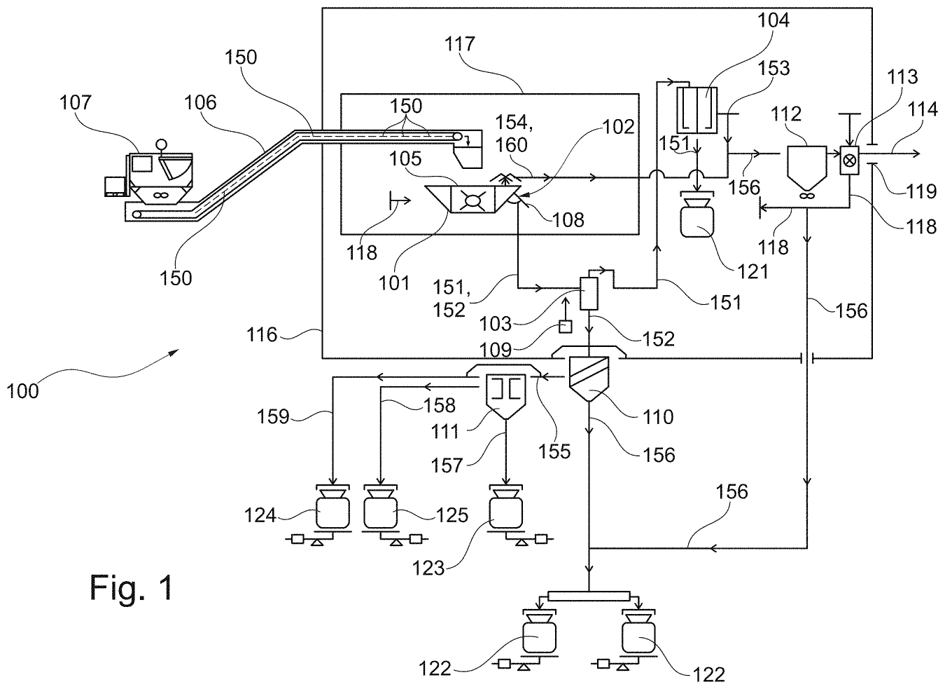

FIG. 1 shows a schematic illustration of a system according to embodiments of the invention according to an exemplary embodiment.

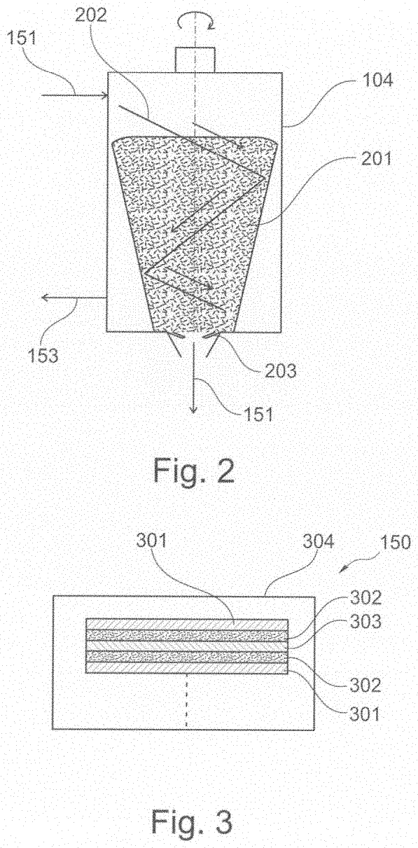

FIG. 2 shows a schematic illustration of the fiber compactor unit according to an exemplary embodiment.

FIG. 3 shows an exemplary illustration of a battery as battery waste.

Same or similar components in different figures are provided with the same reference numbers. The illustrations in the figures are schematic.

FIG. 1 shows a system 100 according to an exemplary embodiment. Embodiments of the present invention relate to a system 100 for processing battery waste. The system 100 comprises a decomposing device 101 for mechanically decomposing the battery waste 150, e.g. electrode foils and plastic separators, in particular to strip-shaped or flake-shaped lightweight portions 151 and heavyweight portions 152, wherein the decomposing device 101 possesses an outlet 102 for commonly discharging the lightweight portion 151 and the heavyweight portion 152. The system 100 comprises a separating unit 103 for separating the lightweight portion 151 from the heavyweight portion 152, wherein the separating unit 103 is coupled with the decomposing device 101 for receiving the lightweight portion 151 and the heavyweight portion 152. The system 100 comprises a fiber compactor unit 104, wherein the fiber compactor unit 104 is coupled with the separating unit 103 for receiving the lightweight portion 151, wherein the fiber compactor unit 104 is configured for compacting the lightweight portion 151 under a separation of a further active material 153.

The target of the processing or the recycling of battery waste 150 is the separation and a corresponding reusability of the heavyweight portions 152, active materials 153, 156 and the lightweight portion 151, 160. For this purpose, at first a decomposition, i.e. a disintegration, of the battery waste 150 in the decomposing device 101 is intended. According to embodiments of the invention, the decomposition of the lightweight portion 151 from the heavyweight portions 152 is achieved mechanically by a decomposing device 101. In the decomposing device 101, by comminuting, shredding, pressing, and cutting, the battery waste 150 is decomposed to the lightweight portion 151 and the heavyweight portion 152. Thereby, in particular the lightweight portion 151 forms thread-shaped structures which may cause a clogging. The heavyweight portion 152 which in particular consists of balled metal constituents, such that besides the thread-shaped lightweight portion 151, also sphere-shaped metal particles are present. Furthermore, in the decomposition, a further lightweight portion 160 and active material 156, which adheres to the lightweight portion 160 or is present in a free manner, are generated. These lightweight portions 160 and active materials 156 may be sucked out of the decomposing device 101 by a suction flow 154.

The battery waste 150 is delivered in capped, closed boxes and is supplied to the system 100 by a forklift, e.g. at a feeding device 107. For this purpose, the boxes are placed in a stationary lifting and tilting device by the operator, which performs the charging of the feeding funnel. The feeding funnel is above a dosing unit which ensures continuously charging the subsequent processing with a mass flow which is as homogenous as possible. The material subsequently arrives via an ascending conveyor 106 in the decomposing device 101, e.g. an impact reactor.

The decomposing device 101 comprises an upper inlet 105 for filling-in the battery waste 150. In particular, the battery waste 150 is conveyable to the inlet 105 by the ascending conveyor 106. Therefore, the battery waste 150 falls in the decomposing device 101 from above based on gravity. Therefore, during the free fall in the decomposing device 101, the battery waste 150 already slightly releases from each other.

The decomposing device 101 (e.g. an impact reactor) decomposes the battery waste 150 and balls (German: verkugelt) the heavyweight portions 152. The decomposing device 101 is operated in a batch operation with a cycle duration of approximately 10 or less minutes.

The decomposing device 101 comprises a shredder rotor. The shredder rotor comminutes and destructs the incoming battery waste 150, such that a decomposition to the lightweight portion 151, a further suckable lightweight portion 160, and the heavyweight portion 152 is enabled.

The outlet 102 of the decomposing device 101 is closable, such that, in particular by a controllable flap, the outlet can be selectively (i.e. in a controlled manner) opened for discharging the decomposed battery waste 150 out of the decomposing device.

According to a further exemplary embodiment, the flap 108 is configured for sequentially opening and for discharging the lightweight portion 151 and the heavyweight portion 152 through the outlet 102 for a predetermined discharging time. The decomposing device 101 is operated in a batch operation, so that, for example during a certain duration, the battery waste 150 is decomposed, i.e. for example shredded, destructed, etc., before the flap 108 opens the outlet 102 and the decomposed battery waste 150 is further discharged and conveyed to the separating device 103.

The discharge out of the decomposing device 101 is performed in two different lines. On the one hand, after expiry of the adjustable cycle time and/or batch operation, a discharge of the course portions, i.e. the lightweight portion 151 and the heavyweight portion 152, through the flap 108 is performed. On the other hand, the further lightweight portions 160 (e.g. fine portions and/or active materials such as nickel-cobalt-concentrate) are sucked via pneumatic units and/or suction units 113 in a suction flow 154. The suction flow 154 may continuously suck the material.

In the separating unit 103, the decomposed mixture of the lightweight portions 151 and the heavyweight portions 152 is spatially separated and is in particular discharged separately. In the separating unit 103, different mechanical separating mechanisms may be utilized. The separating unit 103 may function according to an air classifier. The separating unit 103 correspondingly comprises a blower 109 for generating an air flow. The blower 109 is controllable, such that by the air flow, the lighter lightweight portion 151 is separatable from the heavyweight portion 152, and the lightweight portion 151 is conveyable to the fiber compactor unit 104. The separating unit 103 comprises a downpipe in which the lightweight portion 151 and the heavyweight portion 152, in a loose manner, are conveyable along a conveying direction, in particular vertically falling. The blower 109 provides the air flow substantially perpendicular to the conveying direction. The separating device 103 comprises a vertical downpipe, wherein the decomposed battery waste 150 is introduced centrally from exterior. The air flow is vertically guided from the bottom to the top through the downpipe. Therefore, the lighter lightweight portions 151 are carried upwards to the fiber compactor unit 104, while the heavier heavyweight portion 152, based on gravity, falls downwards and can be further conveyed there.

The separated lightweight portion 151 is conveyed to the fiber compactor unit 104. In the fiber compactor unit 104, the lightweight portions 151 are mechanically compacted and correspondingly collected in a loading station 121 in a loading container or in another loading package, such as a big-bag, and are prepared for the further transport. In the mechanical compaction, further active materials 153 are released, which did not yet separate in the decomposing device 101 from the lightweight portion 151 or the heavyweight portion 152. In the fiber compactor unit 104, also these further active materials 153, in particular nickel oxides and cobalt oxides, can be separately discharged.

The system 100 further comprises the suction unit 113 which is coupled with the decomposing device 101, such that a suction flow is generatable which sucks a further part of the lightweight portion 160 out of the decomposing unit 101. At the mechanical decomposing device 101, by mechanically decomposing, also further lighter lightweight portions 160 are generated. In particular, the further lightweight portion 160 comprises an active material 156, in particular nickel oxide and cobalt oxide. Since these further lightweight portions 160 can be present in the atmosphere in the decomposing device 101 in a dust-type manner, by the suction unit 101, the further lightweight portions 160 are removed and are further transported for processing.

To better separate the further part of the lightweight portion 160 from the heavyweight portion 152 and the lightweight portion 151 which are discharged at the outlet, the decomposing device 101 may comprise an integrated separating system, in particular an air classifier system. The separating system in the decomposing device comprises a deflector wheel classifier, a countercurrent classifier, or a deflection classifier, for example, wherein for example a deflector wheel with a bladed rotor is used. By a feedback-controlled adaption of the circumferential speed and the amount of air of the suction flow 154 out of the decomposing device 101, a specific adaption of the separating grain size (dt) between the particle sizes of the sucked further lightweight portion on the one hand and for example the heavyweight portion 152 and the lightweight portion 151 which are discharged through the outlet 102 on the other hand is possible. Therefore, by the deflector wheel classification, the sucked further lightweight portion 160 can be separated.

The suction unit 113 may comprise a feedback and/or an inflow 118 of the air which is purified from the active material 153, 156 and other lightweight portions 151, 160 into the decomposing device 101. Thereby, a relation of the inflow to the circulating flow in the decomposing device 101 of 10% to 90% is present, depending on the material flow to be separated and the fine portion (dust).

The system 100 further comprises a cyclone separator 112 which is coupled with the suction unit 113, such that the suction flow 154 is flowable in the cyclone separator 112. The cyclone separator 112 is configured to separate the active material 156 from the suction flow 154, which in particular consists of nickel oxide, cobalt oxide, or their compounds. The cyclone separator 112 functions in a manner, that via the centripetal force, the active material 156 can be separated from the exhaust flow and can be separately processed. The exhaust air 114 of the cyclone separator 112 is blown to the outside, e.g. via air/dust filters. The discharge from the cyclone separator 112 is performed via a cell wheel lock (German: Zellradschleuse), for example. The residual material arrives in the dust filter and, by an automatic pressurized-air-cleaning, e.g. in a collecting screw. Via further conveying screws, it is transported to a double loading station 122.

The cyclone separator 112 is further coupled with the fiber compactor unit 104, such that the further active material 153 from the fiber compactor unit 104 is suppliable to the cyclone separator 112. Therefore, also the active material 153 which is obtained in the fiber compactor unit 104 can additionally be separated from the air flow and can be further processed.

The system 100 further comprises a grain size separating unit 110 which is coupled with the separating unit 103 for receiving the heavyweight portion 152. The grain size separating unit 110 is adapted for separating the metal portion 155 and an active material portion 156 which in particular comprises nickel oxide and cobalt oxide by the grain size. The metal portion 155 in particular comprises steel, aluminum, copper, and/or compounds of the same. Above the grain size separating unit, if necessary, the residual ribbon-shaped or flake-shaped lightweight portion (fibers) 152 can be deposited and sucked. This lightweight portion 151 may then also be supplied to the fiber compactor unit 104.

The system 100 further comprises a metal separating unit 111, which is coupled with the grain size separating unit 110 for receiving the metal portion 155, wherein the metal separating unit 111 is configured for separating the metal portion 155 corresponding to the electric conductivity and/or magnetic property. With the metal separating unit 111, in particular conductive and non-conductive, and/or magnetic and non-magnetic fractions of the metal portion 155 are divided. For example, a steel (Fe)-fraction 157, an aluminum-copper fraction 158, and a pure aluminum fraction 159 may be separated and isolated by their electrical conductivity and/or magnetic property.

The system 100 further comprises a housing 116 in which at least the decomposing device 101, the separating unit 103, and the fiber compactor unit 104 are arranged and are sealed from the environment. Due to the enclosing housing 116, the fine matters 154 may be kept within the housing 116 and may be specifically filtered. Via corresponding material locks, for example the battery waste 150 can be introduced in the decomposing device 101, for example via the above-described ascending conveyor 106. Furthermore, further material locks may be provided at the loading station 121, 122, 123, 124, 125, so that a material discharge of the separated residual materials out of the housing can be exchanged without undesirably discharging environmentally harmful fine particles.

The housing 116 comprises at least one suction opening 119, at which the suction unit 113 is couplable, wherein air is dischargeable out of the housing as exhaust air to the environment by the suction unit 113. At the suction unit 113, in particular an air filter is arranged. In particular, and inner housing 117 may further be provided, which in particular encloses the decomposing device 101, since especially many fine particles are generated there. The entire line from the decomposing device 101 (impact reactor) to the loading in the respective loading stations 121, 122, 123, 124, 125 is sealed and is operated at underpressure by suction at multiple positions.

FIG. 2 shows a schematic illustration of the fiber compactor unit 104 according to an exemplary embodiment. The fiber compactor unit 14 comprises a perforated plate 201, on which the lightweight portion 151, in particular the stripe-shaped or flake-shaped plastic portions of the lightweight portion 151, are disposable. The air flow from the separating unit 103 guides the lightweight portion 151 and the active material 153 in the fiber compactor unit 104. The air flow is configured such that the air flow passes the perforated plate 201 and pushes the lightweight portion 151 against the perforated plate 201 and blows the further active material portion 153 through the perforated plate 201. The fiber compactor unit 104 comprises a stripping unit 202 for stripping-off the lightweight portion 151 from the perforated plate 201.

The lightweight portion 151, in particular due to its fiber-type characteristic, remains caught at the perforated plate 201. A further active material portion 153, such as the above-mentioned metals, such as nickel oxide or cobalt oxide, remain in the air flow and pass the perforated plate 201. The further active material portion 153 may be later separated from the air flow by the cyclone separator 112 and by a filter.

By the pressure of the air flow on the lightweight portion 151 which adheres to the perforated plate 201, a compaction is achieved. This is additionally increased, since either continuously or sequentially a stripping and/or scratching of the adhering lightweight portion at the perforated plate 201 is performed by the stripping unit 202, and this released and compacted lightweight portion 151 can be collected at a loading station 121 which is coupled to the fiber compactor unit 104.

The air flow from the separating unit 103 which is carrying the material, in particular enters the fiber compactor unit 104 at the top through the tangential inlet socket, flows in particular through the cone-shaped perforated plate 201 and leaves the fiber compactor unit 104 through the outlet socket. The stripping unit 202 is configured as plugging screw (German: Stopfschnecke) and continuously strips off the deposit of the perforated plate cone 202 and densifies it due to its rotation. The pre-densified material of the lightweight portion is pushed against a membrane 203 at the lower outlet opening. By this continuous process, the material is further densified and the membrane 203 is opened.

In the loading station 121, the lightweight portion 151 is discharged, e.g. in a big-bag.

FIG. 3 shows an exemplary illustration of battery waste 150. The battery waste 150 is a used battery, for example, and firstly comprises a housing 304. The housing 304 of a battery comprises steel or aluminum, for example. In the housing 304, the electrode foils 301, 303 are located, which can function as anode 301 or cathode 303. For example, the electrode foil 301, 303 comprises two layers of metal oxides (for example nickel, cobalt), metal phosphates, or graphite, which are attached on both sides of a central layer, for example made of aluminum and copper. The electrode foils 301, 303 which function as cathode 303 on the one hand and as anode 301 on the other hand, are separated by a plastic separator 302. In the installed battery cell, the plastic separator 302 in particular has the task to electrically separate the cathode 303 and the anode 301 from each other and to ensure the ion exchange. The plastic portion of the plastic separator 302 thus forms an ion-permeable membrane. The plastic separator 302 may be formed ribbon-shaped and comprises a lightweight portion 151, 160 (e.g. polymers, e.g. polyethylene (PE) and polypropylene (PP)).

Supplementary, it is to be noted that “encompassing” does not exclude other elements or steps, and “a” or “an” does not exclude a plurality. Furthermore, it is noted that features or steps which are described with reference to one of the above embodiments may also be used in combination with other features or steps of other above-described embodiments. Reference signs in the claims are not to be construed as limitation.

List of reference signs:,

100 system
101 decomposing device
102 outlet decomposing device
103 separating unit
104 fiber compactor unit
105 inlet
106 ascending conveyor
107 feeding device
108 flap
109 blower
110 grain size separating unit
111 metal separating unit
112 cyclone separator
113 sucking unit
114 exhaust air
116 housing
117 inner housing
118 inflow decomposing device
119 suction opening
121 loading station plastic
122 loading station active material
123 loading station steel
124 loading station copper/aluminum
125 loading station copper/aluminum
150 battery waste
151 lightweight portion
152 heavyweight portion
153 further active material
154 suction flow
155 metal portion
156 active material
157 iron portion
158 aluminum/copper portion
159 aluminum
160 further lightweight portion
201 perforated plate
202 stripping unit
203 membrane
301 electrode foil, anode
302 plastic separator
303 electrode foil, cathode
304 housing

1. System for processing battery waste, the system comprising
a decomposing device for mechanically decomposing the battery waste to a, in particular strip-shaped or flake-shaped, lightweight portion and a heavyweight portion, wherein the decomposing device comprises an outlet for commonly discharging the lightweight portion and the heavyweight portion,
a separating unit for separating the lightweight portion from the heavyweight portion,
wherein the separating unit is coupled with the decomposing device for receiving the lightweight portion and the heavyweight portion, and
a fiber compactor unit,
wherein the fiber compactor unit is coupled with the separating unit for receiving the lightweight portion,
wherein the fiber compactor unit is configured for compacting the lightweight portion under a separation of a further active material.

2. System according to claim 1,
wherein the mechanical decomposing device forms an impact reactor, in particular with a shredder rotor.

3. System according to claim 2,
wherein the decomposing device comprises an upper inlet for filling in the battery waste,
wherein the battery waste is conveyable to the inlet, in particular by an ascending conveyor.

4. System according to claim 1,
wherein the outlet is closable, in particular by a controllable flap, such that the outlet is selectively opened for conveying the decomposed battery waste out of the decomposing device.

5. System according to claim 4,
wherein the flap is configured for sequentially opening and for discharging the lightweight portion and the heavyweight portion through the outlet for a predetermined discharging time,
wherein the discharging time is 0.25 min to 5 min, in particular 2 min.

6. System according to claim 1,
wherein the separating unit is arranged downstream of the outlet.

7. System according to claim 1,
wherein the separating unit comprises a sieve for separating the lightweight portion from the heavyweight portion.

8. System according to claim 1,
wherein the separating unit is a flow classification.

9. System according to claim 8,
wherein the separating unit comprises a blower for generating an air flow,
wherein the blower is controllable such that, by the air flow, the lightweight portion is separatable from the heavyweight portion, and the lightweight portion is conveyable to the fiber compactor unit.

10. System according to claim 9,
wherein the separating unit comprises a downpipe, in which the lightweight portion and the heavyweight portion are conveyable along a conveying direction in a loose manner, in particular vertically falling,
wherein the blower guides the air flow substantially perpendicular to the conveying direction, such that the lightweight portion is separatable from the heavyweight portion by the air flow.

11. System according to claim 1,
wherein the fiber compactor unit comprises a perforated plate, on which the lightweight portion is placeable,
wherein an air flow from the separating unit transports the lightweight portion in the fiber compactor unit, wherein the air flow is directed such that the air flow passes the perforated plate and pushes the lightweight portion against the perforated plate and blows a further active material portion through the perforated plate,
wherein the fiber compactor unit comprises a stripping unit for stripping off the lightweight portion from the perforated plate.

12. System according to claim 1,
wherein the fiber compactor unit comprises a cyclone unit with a swirl pot and a pressing device,
wherein an air flow from the separating unit comprising the lightweight portion is flowable in the cyclone unit,
wherein the air flow is directed such that the air flow circulates in the cyclone unit and thereby separates the lightweight portion from the further active material portion and conveys it downwards in the swirl pot,
wherein the swirl pot is coupled with the pressing device, such that the lightweight portion is suppliable to the pressing device,
wherein the pressing device is configured for compressing the lightweight portion,
wherein the further active material portion, separated from the lightweight portion, is flowable out of the swirl pot together with the air flow,
wherein the pressing device is in particular an edge mill, a roller press, or a briquette press.

13. System according to claim 1, further comprising
a grain size separating unit which is coupled with the separating unit for receiving the heavyweight portion,
wherein the grain size separating unit is configured for separating a metal portion and an active material portion,
wherein the metal portion in particular comprises steel, aluminum, copper and/or compounds of the same,
wherein the active material portion in particular comprises nickel oxide, cobalt oxide, metal oxide, metal phosphates, graphite and/or compounds of the same.

14. System according to claim 13, further comprising
a metal separating unit which is coupled with the grain size separating unit for receiving the metal portion,
wherein the metal separating unit is configured for separating the metal portion.

15. System according to claim 1, further comprising at least one of the following features:
a suction unit which is coupled with the decomposing device, such that a suction flow is generatable which sucks a further part of the lightweight portion out of the decomposing unit;
wherein the decomposing device comprises an integrated separating system, in particular an air classifier system, which is configured such that the further part of the lightweight portion is separatable from the heavyweight portion and the lightweight portion which are discharged at the outlet;
a cyclone separator which is coupled with the suction unit, such that the suction flow is flowable in the cyclone separator,
wherein the cyclone separator is configured for separating an active material from the further lightweight portion of the suction flow,
wherein the active material in particular consists of nickel oxide, cobalt oxide, or their compounds.

16. System according to claim 15,
wherein the cyclone separator is further coupled with the fiber compactor unit, such that the further active material from the fiber compactor unit is suppliable to the cyclone separator.

17. System according to claim 1, further comprising
a housing, in which at least the decomposing device, the separating unit and the fiber compactor unit are arranged and are sealed from the environment.

18. System according to claim 17,
wherein the housing comprises at least one suction opening, to which the suction unit is couplable,
wherein, by the suction unit, air is dischargeable out of the housing to the environment as exhaust air,
wherein in particular an air filter is arranged at the suction unit.

19. System according to claim 1, further comprising
at least one conveyor, in particular a screw conveyor, a trough chain conveyor, a conveyor belt, a tube chain conveyor, a rope conveyor, a vibration conveyor, a bucket conveyor, an elevating conveyor, a Z-conveyor, a waved edge conveyor, or a scraper chain conveyor,
wherein the conveyor is arranged between the outlet of the decomposing unit and the separating unit for transporting the lightweight portion and the heavyweight portion in the separating unit.

20. Method of processing battery waste, the method comprising
mechanically decomposing the battery waste by a decomposing device to a, in particular strip-shaped or flake-shaped, lightweight portion and a heavyweight portion,
wherein the decomposing device comprises an outlet for commonly discharging the lightweight portion and the heavyweight portion,
separating the lightweight portion from the heavyweight portion by a separating unit,
wherein the separating unit is coupled with the decomposing device for receiving the lightweight portion and the heavyweight portion, and
compacting the lightweight portion under a separation of a further active material by a fiber compactor unit,
wherein the fiber compactor unit is coupled with the separating unit for receiving the lightweight portion.
